(19) United States
(12) Patent Application Publication
(10) Pub. No.: US 2021/0363312 A1
(43) Pub. Date: Nov. 25, 2021

(54) GLASS FIBER-FILLED POLYAMIDE

(71) Applicant: INV Nylon Chemicals Americas, LLC, Wilmington, DE (US)

(72) Inventors: Mark Davies, Potto, Northallerton (GB); Gary Stuart Hunt, Yearby, Cleveland (GB); Charles Richard Langrick, Middlesbrough, Cleveland (GB); Carrie Riann Parker, Middlesbrough, Cleveland (GB)

(21) Appl. No.: 16/467,769

(22) PCT Filed: Dec. 18, 2017
(86) PCT No.: PCT/US2017/067080

§ 371 Date: Jun. 7, 2019

Related U.S. Application Data
(60) Provisional application No. 62/436,569, filed on Dec. 20, 2016.

(51) Int. Cl. C08J 5/04; C08K 7/14; C08L 77/06

(52) U.S. Cl. CPC C08J 5/043; C08K 7/14; C08J 2377/06; C08K 2201/004; C08L 77/06

(57) ABSTRACT

The present disclosure relates to glass fiber-filled polyamide compositions. In various aspects, the present disclosure provides a composition including a polyamide having a relative viscosity (RV) of from ≥20 to ≤36. From ≥10 to ≤62 weight percent of the composition is glass fibers blended with the polyamide, based on the weight of the polyamide including the glass fibers. The composition can have a polyamide RV of >22 to <30.2, an elongation-at-break of 4% to 20%, at least 5 wt % of the glass fibers have a length of equal to or greater than 700 microns, or a combination thereof.

### CROSS-REFERENCE TO RELATED APPLICATION

This application claims the benefit of priority to U.S. Provisional Patent Application Ser. No. 62/436,569, filed Dec. 20, 2016, the disclosure of which is incorporated herein in its entirety by reference.

### BACKGROUND

One conventional approach to improving certain mechanical properties of polyamide polymers (e.g., tensile strength) is to increase molecular weight and relative viscosity (RV). Another approach is to incorporate fillers such as glass fibers. The two techniques can be incompatible because the extent to which fillers can be used to improve mechanical properties can be limited with incorporation of filler becoming more difficult with increased RV.

### SUMMARY

In various aspects, the present invention provides a glass fiber-filled polyamide composition including a polyamide having a relative viscosity (RV) of from >22 to <30.2. The glass fiber-filled polyamide composition also includes from ≥10 to ≤62 weight percent glass fibers blended with the polyamide, based on the weight of the polyamide including the glass fibers. The term polyamide also encapsulates the concept of polyamide copolymer.

In various aspects, the present invention provides a glass fiber-filled polyamide composition including a polyamide having a relative viscosity (RV) of from ≥20 to ≤36. The glass fiber-filled polyamide composition includes from ≥10 to ≤62 weight percent glass fibers blended with the polyamide, based on the weight of the polyamide including the glass fibers. The glass fiber-filled polyamide composition has an elongation-at-break of 4% to 20%.

In various aspects, the present invention provides a glass fiber-filled polyamide composition including a polyamide having a relative viscosity (RV) of from ≥20 to ≤36. The glass fiber-filled polyamide composition includes from ≥10 to ≤62 weight percent glass fibers blended with the polyamide, based on the weight of the polyamide including the glass fibers. At least 5 wt % of the glass fibers have a length of equal to or greater than 700 microns.

In various aspects, the present invention provides a method of making the glass fiber-filled polyamide composition described herein. The method can include blending the polyamide and the glass fibers to form the glass fiber-filled polyamide composition, which can be a finished (e.g. room temperature) polyamide composition.

It would be desirable to provide a relatively high strength filled polyamide using a relatively low RV polyamide. In various aspects, the composition including the polyamide and the glass fibers of the present disclosure can have certain advantages over polyamide compositions, at least some of which are unexpected. In various aspects, contrary to conventional understanding of the relationship between RV and polyamide properties, a glass-filled composition including a lower RV polyamide can have better properties (e.g., tensile strength, tensile modulus, flexural strength, flexural modulus, impact strength, or a combination thereof) than a composition including a glass-filled higher RV polyamide.

In some aspects, the polymer produced by the method of the disclosure contains substantially no materials with a melting point higher than the maximum temperature used during the polymerization reaction, avoiding unmelted material from previous batches contaminating the copolymer product. In some aspects, the polymer is produced by the method without the use other additives, avoiding contamination of the product with additives.

In various aspects, the maximum temperature used during the polymerization reaction is less than or equal to about 300° C., thereby avoiding thermal degradation of the polymer material and the resulting high melting materials. Avoidance of high melting materials during the polymerization process can be particularly advantageous to yield better quality polymer in the subsequent batches. Therefore, in various aspects, the polyamide polymer of the present disclosure can have better mechanical properties than a corresponding polymer made by a different method, such as a method involving higher temperatures.

In various aspects, the glass fiber-filled polyamide composition of the present invention can have a higher elongation-at-break than other glass fiber-filled polyamide composition. In various aspects, the glass fiber-filled polyamide composition of the present composition can have a larger distribution of longer glass fibers than other glass fiber-filled polyamide compositions, and due to the lower RV of the polyamide can be formed using less shearing resulting in less breakage of the glass fibers as compared to other glass fiber-filled polyamide compositions.

### BRIEF DESCRIPTION OF THE FIGURES

The drawings illustrate generally, by way of example, but not by way of limitation, various aspects discussed in the present document.

FIG. 1 illustrates observed relationships between RV and glass fiber loading limits for nylon 66 samples including various amounts of glass fibers, in accordance with various aspects. In the area above the dotted line processing was poor, whilst in the area below the dotted line acceptable processing was experienced.

FIGS. 2A-C illustrate tensile strength, flexural strength and notched Izod impact strength, respectively, for samples of nylon 66 at 22, 25, 30 and 35 RV and glass loadings of 50, 55 and 60 weight percent, in accordance with various aspects.

FIG. 3 illustrates observed relationship between apparent shear viscosity (in Pa.$) measured at 275° C. and shear rate (in sec⁻¹), in accordance with various aspects.

FIG. 4 illustrates observed relationship between transient extensional viscosity (in kPa·s) measured at 275° C. and extensional stress (in kPa), in accordance with various aspects.

FIG. 5 illustrates observed relationship between the glass fiber (GF) length (μm) and corresponding % values, as well as calculated weight average distributions, in accordance with various aspects.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

The polymers described herein can terminate in any suitable way. In some aspects, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Composition Including a Polyamide and Glass Fibers (GF).

In various aspects, the present invention provides a glass fiber-filled polyamide composition including a polyamide having a relative viscosity (RV) of from ≥20 to ≤36. The glass fiber-filled polyamide composition also includes from ≥10 to ≤62 weight percent glass fibers blended with the polyamide, based on the weight of the polyamide including the glass fibers. The glass fiber-filled polyamide can have a polyamide RV of >22 to <30.2, an elongation-at-break of 4% to 20%, at least 5 wt % of the glass fibers can have a length of equal to or greater than 700 microns, or any combination thereof. The glass fiber-filled polyamide can be a finished polyamide composition, for example, a polyamide blend that has cooled to approximately room temperature and hardened after blending with the glass fibers and any other optional additives.

In various aspects, the present invention provides a glass fiber-filled polyamide composition including a polyamide having a relative viscosity (RV) of from ≥20 to ≤36. The glass fiber-filled polyamide composition includes from ≥10 to ≤62 weight percent glass fibers blended with the polyamide, based on the weight of the polyamide including the glass fibers. At least 5 wt % of the glass fibers have a length of equal to or greater than 700 microns.

In various aspects, the lower relative viscosity of the polyamide can allow the composition to have a higher glass fiber content than other polyamide compositions and to have correspondingly improved properties. Various properties can be inversely related to the RV of the polyamide (e.g., RV under high or maximum practical loading of the GF), such as tensile strength (e.g., measured in accordance with ASTM D638-14), tensile modulus, flexural strength, flexural modulus, impact strength, or a combination thereof. For example, the tensile strength of the composition having RV of from ≥24 to ≤26 including a maximum loading of the glass fibers is greater than the tensile strength at of the composition having RV from ≥29 to ≤31 including a maximum loading of the glass fibers, both measured in accordance with ASTM D638-14.

The polyamide can have any suitable AEG (amide end group) value, such as in the range of ≥30 to ≤90 moles per million grams (mpmg). The AEG value can be controlled via any suitable method, such as by use of acetic acid capping during polymerization. Acetic acid termination can be used to produce a polyamide having a lower RV.

The polyamide can have any suitable RV (e.g., as measured in a 8.4 wt % solution in 90% formic acid), such as from 20 to 40, 21 to 39, 23 to 39, 25 to 39, 20 to 39, 20 to 38, 20 to 36, ≥22 to ≤36, ≥20 to ≤33, ≥21 to ≤32, ≥22 to ≤30, ≥23 to ≤27, ≥20 to ≤36, ≥20 to ≤33, ≥21 to ≤32, ≥22 to ≤30.2, ≥22 to ≤30.0, ≥22 to ≤29, from ≥23 to ≤27, or 20 or less, or less than, equal to, or greater than 20.5, 21, 21.5, 22, 22.5, 23, 23.5, 24, 24.5, 25, 25.5, 26, 26.5, 27, 27.5, 28, 28.5, 29, 29.5, 30, 31, 32, 33, 34, 35, 36, 37, 38, 39, or about 40 or more. The RV can be determined without the glass fibers mixed with the polyamide, wherein the polyamide is optionally free of any other materials that are in the glass fiber-filled polyamide composition (e.g., the substantially pure polyamide is measured for RV) or these materials are optionally included in the polyamide during the RV determination, such as if they affect RV.

An alternative method of determining the RV is to measure the Viscosity Number (VN, sometime referred to as Viscosity Index) of the polyamide according to ISO 307 and use the conversion relationships for N66 within the ISO standard to convert the VN to RV. In the case of N66, by way of non-limiting example, a VN (determined as a 0.5 w % solution in 96% sulphuric acid) of 83.93 corresponds to an RV of 25. The ISO standard gives an equation for the interconversion as VN=−206.52124+90.23355×ln(RV). Using this equation, an RV of 22 would correspond to a VN of about 72.4 ml/g, and an RV of 36 would correspond to a VN of 116.8 ml/g. Strictly this relationship is for N66 but for the purposes herein may be applied to other polyamides being useful to do so when the polyamide has poor solubility characteristics in 90% formic acid but may be dissolved as a 0.5 w % solution in 96% sulphuric acid for solution viscosity determinations.

For example, EP220167 measures Viscosity Index (also called Viscosity Number) according to ISO 307, this a solution viscosity measured at 0.5 w % in 96% sulphuric acid. ISO 307 also gives conversion formulas for this purpose. In the Examples of the present application, RV is measured by a method functionally equivalent to ASTM D789. In EN ISO 307:2007, a formula is given on page 29 for the relationship between Viscosity Number (VN) and RV: VN=−206.52124+90.23355×ln(RV); therefore, RV=exp((VN+206.52124)/90.23355)). In Experimental section of EP220167 three N66 base polymers are described: PA1 VI (VN)=135 ml/g, corresponding to a calculated RV of 44.08; PA2 VI (VN)=98 ml/g, corresponding to a calculated RV of 29.2; PA3 VI (VN)=101 ml/g, corresponding to a calculated RV of 30.2.

The composition can include one type of glass fibers or multiple types of glass fibers. The glass fibers may have cross-sectional shapes other than round, for example oval or rectangular or multilobal, or H or I shaped. The one or more glass fibers can form any suitable proportion of the composition, such as ≥18 weight percent to ≤60 weight percent, ≥15 weight percent to ≤50 weight percent, ≥20 weight percent to ≤40 weight percent, ≥30 weight percent to ≤50 weight percent of the composition is glass fibers, or about 33 weight percent of the composition is glass fibers. The glass fibers can be any suitable glass fibers, such as glass fibers including soda-lime glass, fused silica glass, borosilicate glass, lead-oxide glass, aluminosilicate glass, oxide glass, glass with high zirconia content, or a combination thereof. Glass fibers can have any suitable dimensions. The glass fibers can have a length of about 0.1 mm to about 500 mm, about 0.1 mm to about 100 mm, about 0.5 mm to about 50 mm, about 1 mm to about 5 mm, or about 0.1 mm or less, or less than, equal to, or greater than about 0.2 mm, 0.4, 0.6, 0.8, 1, 2, 3, 4, 5, 6, 8, 10, 12, 14, 16, 18, 20, 25, 30, 35, 40, 45, 50, 60, 70, 80, 90, 100, 125, 150, 175, 200, 225, 250, or about 500 mm or more. Glass fibers can have a diameter of about 0.1 microns to about 10 mm in diameter, about 0.001 mm to about 1 mm in diameter, or about 0.1 microns or less, or less than, equal to, or greater than about 1 micron, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90 microns, 0.1 mm, 0.2, 0.4, 0.6, 0.8, 1, 2, 3, 4, 5, 6, 7, 8, 9 mm, or about 10 mm or more.

In various aspects the glass fiber-filled polyamide composition can have a greater concentration of longer glass fibers than other glass fiber-filed polyamide composition. For example, due at least in part to the lower RV of the polyamide, the glass fiber-filled polyamide composition can be formed via blending using less force (e.g., less shear), which breaks fewer fibers and leaves more fibers in an unbroken or less broken state. For example, in various aspects, at least 5 wt % of the glass fibers have a length of equal to or greater than 700 microns, or less than, equal to, or greater than 6 wt %, 7, 8, 9, 10, 11, 12, 13, 14, 15, 16, 17, 18, 19 wt %, or 20 wt % of the glass fibers have a length of equal to or greater than 700 microns. In various aspects, at least 15 wt % of the glass fibers have a length of equal to or greater than 600 microns, or less than, equal to, or greater than 16 wt %, 17, 18, 19, 20, 21, 22, 23, 24, 25, 26, 27, 28, 29, or 30 wt % or more of the glass fibers have a length of equal to or greater than 600 microns. In various aspects, the wt % ranges described in this paragraph can be determined using glass fibers having an initial length of 3 mm and a diameter of 10 microns, or can be determined using any suitable length and diameter of fibers, such as any suitable length and diameter described herein.

In various aspects the glass fiber-filled polyamide composition has an elongation-at-break that is higher than other glass fiber-filled polyamide compositions The glass fiber-filled polyamide composition can have an elongation-at-break of 4% to 20%, 4% to 6%, 4.3% to 5.2%, or 4% or less, or less than, equal to, or greater than 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.5, 7, 7.5, 8, 8.5, 9, 9.5, 10, 11, 12, 13, 14, 15, 16, 17, 18, 19, or about 20% or more. The elongation-at-break can be measured in accordance with ISO 527.

The composition can include any material in addition to the homopolymer. The composition can include a polyester such as poly(ethylene terephthalate) or polycaprolactone; a polycarbonate; a polyether; an epoxy polymer; an epoxy vinyl ester polymer; a polyimide such as polypyromellitimide; a phenol-formaldehyde polymer; an amineformaldehyde polymer such as a melamine polymer; a polysulfone; a poly(acrylonitrile-butadiene-styrene) (ABS); a polyurethane; a polyolefin such as polyethylene, polystyrene, polyacrylonitrile, a polyvinyl, polyvinyl chloride, or poly(dicyclopentadiene); a polyacrylate such as poly(ethyl acrylate); a poly(alkylacrylate) such as poly(methyl methacrylate); a polysilane such as poly(carborane-silane); a cyanate resin system; a polyphosphazene; and combinations thereof. The composition can include an elastomer, such as an elastomeric polymer, an elastomeric copolymer, an elastomeric block copolymer, an elastomeric polymer blend, or combinations thereof. Examples of elastomer polymers can include polyolefins, polysiloxanes such as poly(dimethylsiloxane) (PDMS), polychloroprene, and polysulfides; examples of copolymer elastomers may include polyolefin copolymers and fluorocarbon elastomers; examples of block copolymer elastomers may include acrylonitrile block copolymers, polystyrene block copolymers, polyolefin block copolymers, polyester block copolymers, polyamide block copolymers, and polyurethane block copolymers; and examples of polymer blend elastomers include mixtures of an elastomer with another polymer. The composition can include a mixture of these polymers, including copolymers that include repeating units of two or more of these polymers, and/or including blends of two or more of these polymers. The composition can include one or more catalysts, acid generators, solvents, compatibilizers, crosslinkers, anti-blocking agents, coupling agents, fillers, heat stabilizers, light stabilizers, antioxidants, impact modifiers, tackifiers, flame retardants, plasticizers, blowing agents, colorants, dyes, fragrances, foaming additives, processing aids, lubricants, adhesion promoters, biocides, antimicrobial additives, or combinations thereof. In some aspects of the present disclosure, the composition may be a physical blend. In other aspects of the present disclosure, the composition may be a blend which incorporates compatibilizers that may be reactive or non-reactive.

Standard industrial glass filler fibers are useful in accordance with the disclosed composition and process. For information on incorporating glass fibers into nylon 66, see Javangula, S., Ghorashi, B. & Draucker, C.C. Journal of Materials Science (1999) 34: 5143. The disclosed compositions can contain from ≥10 weight percent to ≤60 weight percent glass fibers, for example, ≥15 weight percent to ≤50 weight percent glass fibers, ≥20 weight percent to ≤40 weight percent glass fibers, for example ≥30 weight percent to ≤50, for example 33 weight percent glass fibers, based on the weight of the finished polyamide composition including all additives and fillers (including the glass fibers).

Non-limiting examples of fillers may include talc, mica, clay, silica, alumina, carbon fiber, carbon black, glass fiber, natural fiber, wood flour, wood fibers, non-wood plant fibers, sawdust, wood shavings, newsprint, paper, flax, hemp, wheat straw, rice hulls, kenaf, jute, sisal, peanut shells, soy hulls, or combinations thereof.

In various aspects of the present disclosure, the polyamide resin, such as nylon 66, may be melt kneaded with the pre-determined amount of glass fibers and other additives using industrial compounding or extrusion equipment. For example, the polyamide resin may be supplied to the feed port of the compounding machine and glass fibers may be introduced either at the feed port, at the side feeder port or some combination of the two. Compounding conditions may be properly set in terms of the desired temperature range, extrusion pressure, extrusion time, screw speed, etc. to obtain homogenized melt at the discharge port. The compounded GF-reinforced polymer strands immediately after compounding may follow palletization in the suitable pelletizer with water cooling. The obtained pellets may be useful for further industrial processes, such as injection moulding, for making parts and articles of interest.

### Polyamide.

The glass fiber-filled polyamide composition can include one homopolymer or more than one polymer. The one or more polymer can form any suitable proportion of the composition, such as 38 to 90 weight percent, 40 to 82 weight percent, 50 to 85 weight percent, 60 to 80 weight percent, 50 to 70 weight percent, or 78 weight percent. The polyamide can be a polymer or a copolymer. In some aspects, the polyamide can be N66 (nylon 66), 66/6T (e.g., 70:30 66/6T, a copolymer of nylon 66 and nylon 6T, wherein 66 is a polymer from hexamethylene diamine and adipic acid, and wherein 6T is a polymer from hexamethylene diamine and terephthalic acid), or a combination thereof.

Suitable examples of the polymer resin may include, but are not limited to, AB and AABB type polyamide (nylon) resins such as PA6, PA7, PA8, PA9, PA10, PA11, PA12, PA46, PA66, PA610, PA612, PA1010, PA1212, etc. In the polymer industry, the term “polyamide” is interchangeably used with “nylon”, both having the same meaning to a person skilled in polymer science. For example, polyamide 6 (PA6) is also referred to as nylon 6 (N6). Likewise, polyamide 66 (PA66) is also referred to as nylon 66 or nylon-6,6 (N66).

Examples of suitable polyamides include, but are not limited to, polyhexamethlyeneadipamide (PA66), polycaproamide (PA6), polyenanthamide (PA7), polylaurolactamide (PA12), polyundecaneamide (PA11), polyhexamethylenedodecamide (PA612), and any combination thereof. Examples of suitable polyamides include PA66 (polyhexamethyleneadipamide) and PA6 (polycaproamide).

A large number of procedures are known for producing polyamides, different monomer building blocks, various chain regulators for achieving a desired molecular weight or also monomers with reactive groups for subsequently intended post-treatment procedures beings used depending on the desired end product.

The polyamides produced according to the present disclosure may also be used with other polyamides and/or further polymers.

The polyamide resin can optionally further include at least one copolyamide (e.g., a polyamide that is a copolymer including repeating groups that include an amide group and also including different repeating groups including another group, such as amide or another moeity), then non-limiting examples of suitable monomers to form copolyamides may include caprolactam, aminocaproic acid, 2-methyl-1,5-diaminopentane, sebacic acid, dodecanedioic acid, isophthalic acid, and terephthalic acid.

A polyamide copolymer can be formed from a reaction mixture. The reaction mixture can include adduct A and adduct B. Adduct A can be a 1:1 adduct of a diamine having the structure H₂N—R¹—NH₂, or a salt thereof, and an aliphatic diacid having the structure HO—C(O)—R²—C(O)—OH, or a salt thereof. Adduct B is a 1:1 adduct of the diamine having the structure H₂N—R¹—NH₂, or a salt thereof, and an aromatic diacid having the structure HO—C(O)—R³—C(O)—OH, or a salt thereof. At each occurrence, R¹ can independently be a substituted or unsubstituted (C₁-C₂₀)alkylene. At each occurrence, R² can independently be a substituted or unsubstituted (C₁-C₂₀)alkylene. At each occurrence, R³ can independently be a substituted or unsubstituted (C₆-C₂₀)arylene. The molar ratio of adduct A to adduct B in the reaction mixture can be about 61:39 to about 90:10.

The reaction mixture can include adduct A and adduct B. The reaction mixture can include any suitable materials in addition to adduct A and adduct B, such as one or more solvents (e.g., water, and water miscible solvents such as alcohols), other reactants (e.g., other species that can participate in the polymerization and that can be incorporated in the copolymer, catalysts, and the like. In some aspects, the reaction mixture only includes adduct A, adduct B, and aqueous solvent, and is substantially free of other materials. The molar ratio of adduct A to adduct B in the reaction mixture can be any suitable ratio, such as about 61:39 to about 90:10, about 61:39 to about 80:20, about 65:35 to about 75:25, about 70:30, or about 61:39 or less, or less than, equal to, or greater than about 62:38, 63:37, 64:36, 65:35, 66:34, 67:33, 68:32, 69:31, 70:30, 71:29, 72:28, 73:27, 74:26, 75:25, 76:24, 77:23, 78:22, 79:21, or about 80:20 or more. The concentration of adducts A and B in the reaction mixture can be any suitable concentration. For example, the combined concentration of adducts A and B in the reaction mixture can be about 10 wt % to about 90 wt %, about 40 wt % to about 50 wt %, about 10 wt % or less, or less than, equal to, or greater than about 15 wt %, 20, 22, 24, 26, 28, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 62, 64, 66, 68, 70, 75, 80, 85 wt %, or about 90 wt % or more.

Adduct A can be a 1:1 adduct of a diamine having the structure H₂N—R¹—NH₂, or a salt thereof, and an aliphatic diacid having the structure HO—C(O)—R²—C(O)—OH, or a salt thereof. The adduct can be any suitable material that results from an approximately 1:1 molar ratio of the diamine or a salt thereof being in the presence of the aliphatic diacid or a salt thereof. The adduct can be a mixture of the diamine and the diacid, the adduct can be a material that forms as a result of the mixture of the diamine and the diacid, or a combination thereof. A mixture that forms adduct A need not include exactly a 1:1 molar ratio of the diamine or a salt thereof and the aliphatic diacid or a salt thereof, for example, the mixture can include more diamine than diacid or vice versa. The adduct can be a salt. For example, the carboxylic acid groups can protonate the amine groups to form ammonium/carboxylate ion pairs.

At each occurrence, R¹ can independently be a substituted or unsubstituted (C₁-C₂₀)alkylene. The variable R¹ can be (C₁-C₁₀)alkylene. The variable R¹ can be 2-methylpentylene and the diamine can be 2-methylpentamethylenediamine (MPMD). The variable R¹ can be hexylene and the diamine can be hexamethylenediamine. At each occurrence, R² can independently be a substituted or unsubstituted (C₁-C₂₀)alkylene. The variable R² can be (C₁-C₁₀)alkylene. The variable R² can be butylene and the aliphatic diacid can be adipic acid.

Adduct B can be a 1:1 adduct of the diamine having the structure H₂N—R¹—NH₂, or a salt thereof, and an aromatic diacid having the structure HO—C(O)—R³—C(O)—OH, or a salt thereof. The adduct can be any suitable material that result from an approximately 1:1 molar ratio of the diamine or a salt thereof being in the presence of the aromatic diacid or a salt thereof. The adduct can be a mixture of the diamine and the diacid, the adduct can be a material that forms as a result of the mixture of the diamine and the diacid, or a combination thereof. A mixture that forms adduct B need not include exactly a 1:1 molar ratio of the diamine or a salt thereof and the aromatic diacid or a salt thereof; for example, the mixture can include more diamine than diacid or vice versa. The adduct can be a salt. For example, the carboxylic acid groups can protonate the amine groups to form ammonium/carboxylate ion pairs.

In some aspects, acetic acid may be added to the salt prior to polymerization to limit molecular weight (MW) and relative viscosity (RV) growth during polymerization. Suitable amounts are within the range of 1 ppmw to 5000 ppmw (based on weight of the finished polyamide) for example, 500 to 4000 ppmw, for example, 2000 to 3500 ppmw. For a discussion of acetic acid as an end-capper to control RV gain, see Jacobs and Zimmerman, “Chapter 12: Preparation of 6,6-Nylon and Related Polyamides” from Polymerization Processes, Edited by Charles Schildknect, John Wiley & Sons, (1977) at pages 443-444.

Adducts A and B can be formed separately or together. Forming adducts A and B separately can include forming a mixture that includes a 1:1 molar ratio of the diamine or a salt thereof and the aliphatic diacid or a salt thereof, forming a mixture that includes a 1:1 molar ratio of the diamine or a salt thereof and the aromatic diacid or a salt thereof, and combining adducts A and B (e.g., combining the two mixtures, or purifying adducts A and B and combining the purified adducts). Forming adducts A and B together can include forming a mixture that includes a 1:1 molar ratio of the diamine or a salt thereof and the aliphatic diacid or a salt thereof and that separately includes a 1:1 molar ratio of the diamine or a salt thereof and the aromatic diacid or a salt thereof, such that the number of moles diamine or salt thereof present is equal to the combined number of moles of the aliphatic diacid or a salt thereof and of the aromatic diacid or a salt thereof. Forming adducts A and B together can include forming the adducts at the same or different reaction rates. The adducts formed together can be used as is or can be purified before being used in the reaction mixture.

At each occurrence, R³ can independently be a substituted or unsubstituted (C₆-C₂₀)arylene. Variable R³ can be phenyl and the aromatic diacid can be independently selected from terephthalic acid and isophthalic acid. The variable R³ can be phenyl and the aromatic diacid can be terephthalic acid.

The polyamide copolymer can have any suitable melting point. The polyamide copolymer formed can have various lengths (e.g., various degrees of polymerization), such that the polyamide copolymer exhibits a range of RVs. The polyamide copolymer can have any suitable maximum melting point (e.g., the melting point at which all of the polyamide copolymer formed melts). The polyamide copolymer can have a melting point equal to or less than the maximum temperature used when subjecting the reaction mixture to the conditions sufficient to form the polyamide copolymer. The melting point of the polyamide copolymer can be about 100° C. to about 310° C., about 100° C. to about 300° C., or about 200° C. to about 300° C., or about 100° C. or less. The polyamide copolymer can have a melting point less than or equal to about (e.g., a maximum melting point less than or equal to about) 310° C., 300° C., 295° C., 290° C., 280° C., or about 270° C. or less.

Subjecting the reaction mixture conditions sufficient to form the polyamide copolymer can be performed in a reactor, such as a batch reactor or a continuous reactor. In some aspects, the reactor is an autoclave (e.g., an autoclave having the ability to remove water from a reaction mixture therein).

During the subjecting of the reaction mixture to conditions sufficient to form the polyamide copolymer, the maximum temperature of the reactor can be about 310° C., 300° C., 295° C., 295° C., 290° C., 280° C., or about 270° C. or less.

Subjecting of the reaction mixture to conditions sufficient to form the polyamide copolymer can include removing water from the reaction mixture. Water can be removed from the reaction mixture until water is about 0 wt % to about 30 wt % of the reaction mixture, or about 0 wt %, or about 0.0001 wt % or less, or less than, equal to, or greater than about 0.0005, 0.001, 0.005, 0.01, 0.2, 0.4, 0.6, 0.8, 0.1, 0.2, 0.3, 0.4, 0.5, 0.6, 0.7, 0.8, 0.9, 1, 1.5, 2, 2.5, 3, 4, 5, 6, 7, 8, 9, 10, 12, 14, 16, 18, 20, 22, 24, 26, 28 wt %, or about 30 wt % or more. Removing water from the reaction mixture can include heating the reaction mixture under pressure while removing water, heating the reaction mixture under vacuum while removing water, or a combination thereof. For example, removing water can include heating under pressure with removal of water first, and then heating under vacuum with removal of water second.

The subjecting of the reaction mixture to conditions sufficient to form the polyamide copolymer can include subjecting the reaction mixture to a maximum pressure of about 2070 kPa (300 psi), or to a pressure of about 0.001 kPa to about 20,000 kPa, 0.1 kPa to about 2100 kPa, about 27.6 kPa (4 psi) to about 1860 kPa (270 psi), or about 0.001 kPa or less, or less than, equal to, or greater than about 0.01 kPa, 0.1, 1, 2, 4, 6, 10, 15, 20, 25, 50, 75, 100, 200, 250, 500, 750, 1,000, 1,250, 1,500, 1,750, 2,000, 2,500, 5,000, 10,000, or about 20,000 kPa or more.

The subjecting of the reaction mixture to conditions sufficient to form the polyamide copolymer can include subjecting the reaction mixture to a temperature of about (e.g., not exceeding) about 100° C. to about 310° C., about 200° C. to about 300° C., or less than or equal to about 310° C., 300° C., 295° C., 290° C., 280° C., or about 270° C. or less.

In various aspects, a reactor containing the reaction mixture (e.g., an autoclave) can be sealed and the reaction mixture can be heated gradually to about 100° C. to about 250° C. (e.g., about 200° C.) with removal of water to concentrate the reaction mixture to about 60 wt % to about 95 wt % (e.g., 70 wt % to about 85%). The concentrated reaction mixture can be heated until a pressure of 200 kPa to about 2100 kPa (e.g., about 1724 kPa (250 psi) to about 1860 kPa (270 psi)) is achieved. The reaction mixture can be held at this pressure with gradual distillation of water until a reaction mixture temperature of about 200° C. to about 290° C. (e.g., 250° C. to about 270° C.) is achieved. The wt % water in the reaction mixture can be brought to about 15 wt % to about 30 wt % via the gradual distillation of the water. The reaction mixture pressure can be released over a suitable period (e.g., 15-45 mins) until it reaches atmospheric pressure. The reaction mixture pressure can be gradually reduced under vacuum to about 0.001 kpa to about 50 kPa (e.g., about 28 kPa (4 psi) to about 103 kPa (15 psi) and can be held at this pressure while reaction mixture is heated to 270° C. to about 310° C. (e.g., about 290° C. to about 300° C.). The reaction mixture can be held at this temperature and pressure for a suitable period (e.g., 5-30 mins) before the polymer melt is discharged from the autoclave.

Polyamides can be manufactured by polymerization of dicarboxylic acids and diacid derivatives and diamines. In some cases, polyamides may be produced via polymerization of aminocarboxylic acids, aminonitriles, or lactams. The dicarboxylic acid component is suitably at least one dicarboxylic acid of the molecular formula HO₂C—R¹—CO₂H; wherein R¹ represents a divalent aliphatic, cycloaliphatic or aromatic radical or a covalent bond. R¹ suitably includes from 2 to 20 carbon atoms, for example 2 to 12 carbon atoms, for example 2 to 10 carbon atoms. R¹ may be a linear or branched, for example linear, alkylene radical including 2 to 12 carbon atoms, or 2 to 10 carbon atoms, for example 2, 4, 6 or 8 carbon atoms, an unsubstituted phenylene radical, or an unsubstituted cyclohexylene radical. Optionally, R¹ may contain one or more ether groups. For example, R¹ is an alkylene radical, for example a linear alkylene radical, including 2 to 12 carbon atoms, or 2 to 10 carbon atoms, for example 2, 4, 6 or 8 carbon atoms.

Specific examples of suitable dicarboxylic acids include hexane-1,6-dioic acid (adipic acid), octane-1,8-dioic acid (suberic acid), decane-1,10-dioic acid (sebacic acid), dodecane-1,12-dioic acid, 1,2-cyclohexanedicarboxylic acid, 1,3-cyclohexanedicarboxylic acid, 1,4-cyclohexanedicarboxylic acid, 1,2-cyclohexanediacetic acid, 1,3-cyclohexanediacetic acid, benzene-1,2-dicarboxylic acid (phthalic acid), benzene-1,3-dicarboxylic acid (isophthalic acid), benzene-1,4-dicarboxylic acid (terephthalic acid), 4,4′-oxybis(benzoic acid), and 2,6-naphthalene dicarboxylic acid. A suitable dicarboxylic acid is hexane-1,6-dioic acid (adipic acid).

The diamine component is suitably at least one diamine of the formula H₂N—R²—NH₂; wherein R² represents a divalent aliphatic, cycloaliphatic or aromatic radical. R² suitably includes from 2 to 20 carbon atoms, for example 4 to 12 carbon atoms, for example 4 to 10 carbon atoms. R² may be a linear or branched, for example linear, alkylene radical including 4 to 12 carbon atoms, for example 4 to 10 carbon atoms, for example 4, 6 or 8 carbon atoms, an unsubstituted phenylene radical, or an unsubstituted cyclohexylene radical. Optionally, R² may contain one or more ether groups. For example, R² is an alkylene radical, for example a linear alkylene radical, including 4 to 12 carbon atoms, or 4 to 10 carbon atoms, for example 2, 4, 6 or 8 carbon atoms.

Specific examples of suitable diamines include tetramethylene diamine, pentamethylene diamine, hexamethylene diamine, octamethylene diamine, decamethylene diamine, dodecamethylene diamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine, 2,2,7,7-tetramethyloctamethylene diamine, 1,2-cyclohexanediamine, 1,3-cyclohexanediamine, 1,4-cyclohexanediamine, 4,4′-diaminodicyclohexylmethane, benzene-1,2-diamine, benzene-1,3-diamine and benzene-1,4-diamine. A suitable diamine is hexamethylene diamine.

The aromatic diacid is suitably at least one diacid of the formula HO—C(O)—R³—C(O)—OH, wherein the variable R³ is substituted or unsubstituted aryl, such as phenyl. In one aspect, the aromatic diacid is terephthalic acid.

The polyamide resin can further include a catalyst. In one aspect, the catalyst can be present in the polyamide resin in an amount ranging from 10 ppm to 1,000 ppm by weight. In another aspect, the catalyst can be present in an amount ranging from 10 ppm to 300 ppm by weight. The catalyst can include, without limitation, phosphorus and oxyphosphorus compounds, such as, phosphoric acid, phosphorous acid, hypophosphorous acid, hypophosphoric acid, arylphosphonic acids, arylphosphinic acids, salts thereof, and mixtures thereof. In one aspect, the catalyst can be sodium hypophosphite (SHP), manganese hypophosphite, sodium phenylphosphinate, sodium phenylphosphonate, potassium phenylphosphinate, potassium phenylphosphonate, hexamethylenediammonium bis-phenylphosphinate, potassium tolylphosphinate, or mixtures thereof. In one aspect, the catalyst can be sodium hypophosphite (SHP).

The reinforcement of polyamides can be carried out by incorporating for example glass fibers or mineral fibers in the polyamide melt, for example from an extruder.

### EXAMPLES

Various aspects of the present disclosure can be better understood by reference to the following Examples which are offered by way of illustration. The present disclosure is not limited to the Examples given herein.

The following materials were characterized: N66 (unfilled nylon 66) and N66 GF (compounded blends of nylon 66 and glass fibers in the 30 to 60 wt. % range). The glass fibers used were standard short glass fibers, for example, commercially available product, Chopped Strand for PA, from Chongqing Polycomp International Corp. (www.cpicfiber.com). In the Examples, E-glass Chopped strands Grade 301HP having 3-mm chopped length and 10-μm filament diameter glass fiber was used. In the present disclosure, the term “glass fiber” is abbreviated as “GF” which is understood to be a standard nomenclature in the polymer and compounding industry. The amount of GF in the polymer sample is represented as wt. % of the total, unless stated otherwise.

Molecular weight of polyamide resins is typically inferred by the measurement of solution viscosity. The two most common methods are: (i) ASTM D789 for relative viscosity (RV) measurement, and (ii) ISO 307 using sulfuric acid to obtain viscosity number (VN) values. Viscosity values and trends to be considered are determined by the same method, regardless of which method is selected.

The term “RV”, used herein in the Examples, refers to relative viscosity of a polymer sample as measured (unless otherwise indicated) in an 8.4 wt % solution in 90% formic acid. HDT is heat deflection temperature in ° C., which is measured in accordance with ISO 175. The tensile strength (MPa) of the materials is measured in accordance with ASTM D638-14 method. The tensile modulus (MPa) of the materials is measured in accordance with ISO 527. The % elongation-at-break of the materials is measured in accordance with ISO 527. The flexural stress (MPa) at 3.0% strain of the materials is measured in accordance with ISO 178. The flexural modulus (MPa) of the materials is measured in accordance with ISO 178. The Izod notched impact strength (23° C., kJ/m²) of the materials is measured in accordance with ISO 180 method.

The technical terms “shear viscosity” or “apparent shear viscosity” or “apparent melt viscosity”, as used herein, refer to polymer melt's resistance to the applied shear flow or rate. The polymer melt viscosity at infinite slow shear is known as zero shear rate viscosity (ƒ₀). In general, the shear rate is measured in the units of reciprocal time scale, such as sec⁻¹, for example, 1 sec⁻¹, 10 sec⁻¹, 100 sec⁻¹, 1000 sec⁻¹. The technical terms “extensional viscosity” or “elongational viscosity”, as used herein, refer to a viscosity coefficient when applied stress is extensional or elongational stress, such as during polymer melt extrusion. Units of viscosity are Pascal·sec (abbreviated as Pa·s) or kiloPascal·sec (kPa·s).

### Example 1. Polyamide Samples

The measured properties of the materials are shown in Table 1. In the table, RV values refer to the polymer samples according to various aspects of this disclosure, and in this case nylon 66, before the compounding step with glass fibers and other additives.

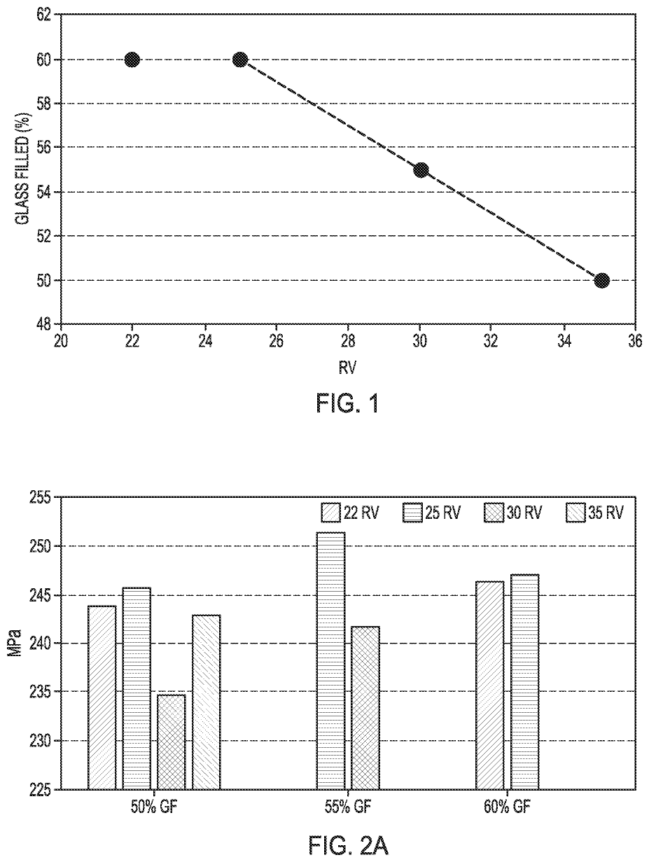

FIG. 1 illustrates the observed relationship between RV and practical glass loading limits for Samples 2, 7, 12, and 15. In the area above the dotted line processing was poor, whilst in the area below the dotted line acceptable processing was experienced.

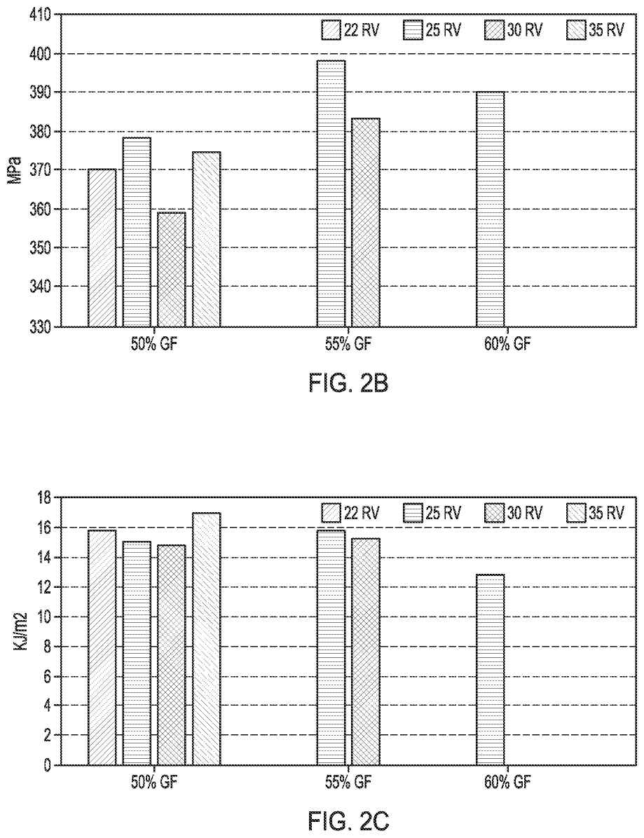

FIGS. 2A-C illustrate tensile strength, flexural strength and notched Izod impact strength, respectively, for samples of nylon 66 at 22, 25, 30 and 35 RV and glass fiber loadings of 50, 55, and 60 wt. % for each of RV samples and according to Samples 1, 2, 5, 6, 7, 11, 12 and 15.

Table 1 also includes mechanical strengths data for several commercially available GF-reinforced PA66 polymer resins. Ultramid® A3EG10 is sold by BASF and is a glass fiber reinforced injection moulding grade resin. Except for the measured RV value of 42, all listed properties are taken from the BASF Brochures Product Datasheet published for Ultramid® A3EG10 resin. Zytel® 70G50HSL is a 50% glass reinforced nylon 66 resin commercially sold by DuPont. Its listed properties are taken from the DuPont Product Information published for Zytel® 70G50HSL resin. NILAMID® A3 W GF55 is a heat-stabilized Polyamide 66 (nylon 66) compound, 55% glass fiber reinforced, commercially available from Celanese Corp. The listed mechanical properties for NILAMID® A3 W GF55 resin are available on www.materialdatacenter.com. Akromid®A3 GF 60 1 is a 60% glass fiber reinforced and heat stabilized polyamide 66 commercially available from Akro-Plastic GmbH. Its listed mechanical properties are available on http://www.matweb.com.

TABLE 1
Samples.

| | | | Tensile properties (5 specimens, | | | | Flexural properties | | | | | Impact properties | |
|---|---|---|---|---|---|---|---|---|---|---|---|---|---|
| | | | 1 mm for 1st min then 5 mm/min) | | | | | | Flex stress | | HDT@ | Notched | |
| | Sample Details | | Tensile | | | Elongation | Flexural | | @ 3.0% | Flexural | 0.34 mm, | Izod (1J | |
| Sample | | wt % | strength | Std. | Modulus | @ break | strength | Std. | strain | modulus | 1.8 MPa | Hammer) | Std. |
| No. | RV | GF | (MPa) | Dev. | (MPa) | (%) | (MPa) | Dev. | (MPa) | (MPa) | stress | Re (KJ/m²) | Dev. |
| 1 | 22 | 50 | 243.8 | 2.04 | 17320 | 4.74 | 369.96 | 6.47 | 351.2 | 14874 | 256.5 | 15.69 | 0.59 |
| 2 | 22 | 60 | 246.4 | 4.8 | 23420 | 4.4 | n/a | n/a | n/a | n/a | n/a | n/a | n/a |
| 3 | 25 | 0 | 82.02 | 3.0 | 3036 | 5.64 | 115.98 | n/a | n/a | 2794 | 73.07 | 3.69 | n/a |
| 4 | 25 | 33 | 197.0 | 4.6 | 10540 | 4.6 | 301.7 | n/a | n/a | 9702 | 254.7 | 11.17 | n/a |
| 5 | 25 | 50 | 245.4 | 3.32 | 16180 | 4.81 | 378.02 | 3.13 | 358.6 | 14900 | 257.43 | 15 | 0.94 |
| 6 | 25 | 55 | 251.4 | 1.74 | 18560 | 4.83 | 397.86 | 6.29 | 389.2 | 16856 | 255.13 | 15.82 | 0.8 |
| 7 | 25 | 60 | 247 | 4.29 | 20380 | 4.4 | 389.92 | 9.34 | n/a | 18496 | 258.37 | 12.86 | 1.4 |
| 8 | 26 | 50 | n/a | n/a | n/a | n/a | n/a | n/a | n/a | n/a | n/a | n/a | n/a |
| 9 | 30 | 0 | 81.7 | 4.62 | 2976 | 5.05 | 115.94 | n/a | n/a | 2845 | 72.1 | 3.68 | n/a |
| 10 | 30 | 33 | 204.4 | 0.80 | 10420 | 4.9 | 303.7 | n/a | n/a | 9624 | 251.57 | 10.88 | n/a |
| 11 | 30 | 50 | 234.6 | 1.36 | 15980 | 4.84 | 358.6 | 2.58 | 340.2 | 13828 | 255.27 | 14.77 | 0.73 |
| 12 | 30 | 55 | 241.8 | 1.6 | 18020 | 4.68 | 382.88 | 2.66 | 376.8 | 16506 | 257.57 | 15.18 | 0.81 |
| 13 | 35 | 0 | 84.78 | 0.52 | 2968 | 7.91 | 110.74 | n/a | n/a | 2672 | 71.55 | 3.94 | n/a |
| 14 | 35 | 33 | 203.8 | 1.47 | 10520 | 5.08 | 301.04 | n/a | n/a | 9498 | 251.07 | 11.32 | n/a |
| 15 | 35 | 50 | 242.8 | 1.47 | 16000 | 5.1 | 373.44 | 1.97 | 345.8 | 14576 | 256.8 | 16.95 | 0.58 |
| 16 | 38 | 35 | 132.5 | n/a | 11312 | n/a | n/a | n/a | n/a | n/a | n/a | 11.73 | n/a |
| 17 | 38 | 50 | n/a | n/a | n/a | n/a | n/a | n/a | n/a | n/a | n/a | n/a | n/a |
| 18 | ~40 | 33 | 194 | n/a | 10300 | 5.18 | 275.9 | n/a | 228 | 9110 | 246.53 | 9.93 | n/a |
| 19 | 48 | 0 | 83.28 | 1.21 | 2952 | 18.0 | 116.1 | n/a | n/a | 2815 | 68.17 | 3.81 | n/a |
| 20 | 48 | 33 | 190.0 | 0.89 | 10360 | 4.83 | 290.2 | n/a | n/a | 9490 | 248.6 | 10.68 | n/a |
| 21* | 48 | 50 | 226.0 | n/a | 15720 | 4.30 | 362.8 | n/a | n/a | 15146 | n/a | 13.88 | n/a |
| Ultramid ® | 42 | 50 | 240 | n/a | 16800 | 2.5 | 360 | n/a | n/a | 15000 | 250 | 13 | n/a |
| A3EG10 | | | | | | | | | | | | | |
| Zytel ® | n/a | 50 | 260 | n/a | 17300 | 2.7 | n/a | n/a | n/a | n/a | 258 | 16 | n/a |
| 70G50HSL | | | | | | | | | | | | | |
| NILAMID ® | n/a | 55 | 250 | n/a | 17000 | 2.7 | n/a | n/a | n/a | n/a | 250 | n/a | n/a |
| A3 W GF55 | | | | | | | | | | | | | |
| Akromid ® | n/a | 60 | 260 | n/a | 20500 | 2.0 | 400 | n/a | n/a | 19800 | 260 | 19 | n/a |
| A3 GF 60 1 | | | | | | | | | | | | | |

*averaged data

### Example 2. Rheological Properties

Capillary rheology of pre-dried nylon 66 samples was determined for Sample 5 (RV of 25 with 50 wt. % GF and 0.04 wt. % moisture) and Sample 17 (RV of 38 with 50 wt. % GF and 0.038 wt. % moisture) samples at 275° C. These Samples were characterized using a Rosand capillary rheometer at 275° C. The sample was melted in the heated rheometer barrel prior to extrusion. The melt was extruded over a range of flow (shear) rates through a die 1 mm in diameter and the pressure drop recorded just above the die entry at each rate. Two parallel measurements using dies of different lengths (in this case 20 mm and 0.25 mm) were made to allow a die entry pressure drop correction (Bagley) to be made. The apparent shear and transient extensional viscosity (Cogswell analysis) were calculated from the die geometries and pressure drops recorded. Units of apparent melt viscosity are Pa·s. Shear rate is a function of the volumetric flow rate and die geometry and is measured in reciprocal seconds (O).

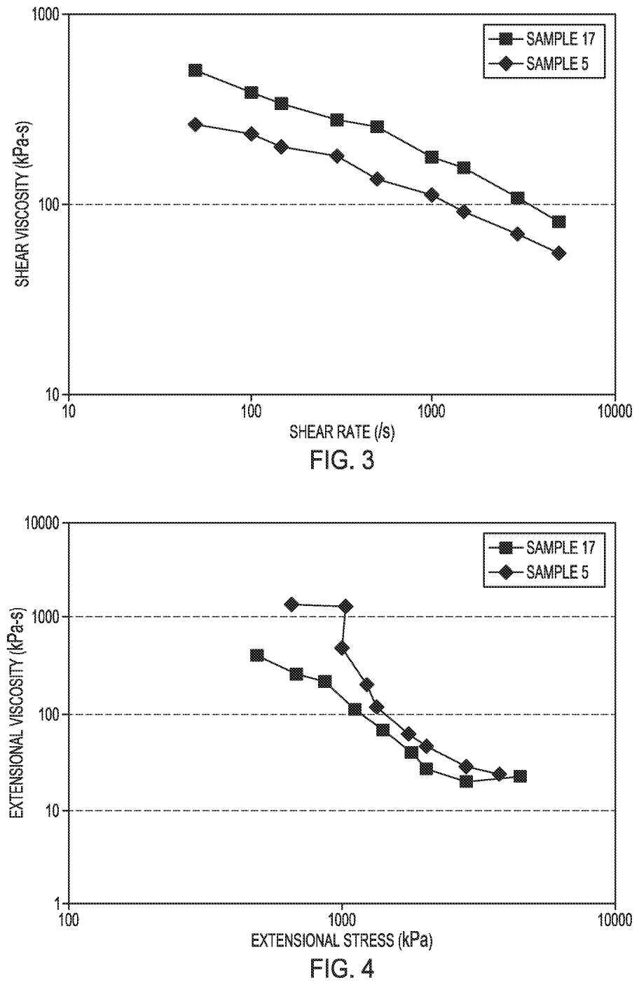

FIGS. 3 and 4 illustrate the measured capillary rheology data for Sample 5 (diamonds) and Sample 17 (squares). FIG. 3 illustrates the apparent shear viscosity data measured at 275° C. with shear rate (in sec⁻¹) on the X-axis and shear viscosity (in Pa·s) on the Y-axis. FIG. 4 illustrates transient extensional viscosity data measured at 275° C. with extensional stress (in kPa) on the X-axis and extensional viscosity (in kPa·s) on the Y-axis. Table 2 gives the apparent melt viscosity data for samples 5 and 17 (Pa·s, measured at 275° C.) at 100 s⁻¹ and 1000 s⁻¹ apparent shear rates.

TABLE 2
Apparent melt viscosity of Samples 5 and 16.

Apparent Melt Viscosity (Pa · s)

| Sample | @ 100 sec⁻¹ | @ 1000 sec⁻¹ |
|---|---|---|
| 5 | 234.9 | 110.8 |
| 17 | 387.2 | 176.1 |

### Example 3. Glass Fiber Length Distribution in Glass Fiber-Reinforced Polymer Samples

For the glass fiber (GF)-reinforced polymer samples of Table 1, GF length distribution was determined by keeping the GF intact as much as possible during sample preparation, by having proper concentration of GF dispersed in the solvent used, and by taking proper image contrast for automatic image process software. The instruments and apparatus in the GF length distribution determination method included Leica DM RX Optical Microscope, Olympus DP71 digital video camera, Image ProPlus Image process software. Ethylene glycol was used as a solvent.

Each analyzed GF-reinforced polymer sample was ashed at 650° C. in ash oven for 30 minutes to yield ashed GF in compact cake form. About 20 cc of ethylene glycol was added to a vial containing about 0.5 g of ashed GF sample and kept overnight or longer for proper wetting of the GF. Upon wetting, the vial was gently shaken to disperse the GF and a representative dispersion sample was withdrawn for analysis. The GF dispersion image was taken and analyzed using Image ProPlus software for the determination of GF length distribution.

The GF length distribution data for the 50 wt. % GF-reinforced N66 polymer samples, namely, 26 RV, 38 RV and 48 RV resins (Samples 8, 17, 21) are tabulated in Table 3. In Table 3, the % value for each GF length range (i.e., individual rows) is calculated from the its corresponding Counts value divided by the Total Counts value (i.e., last row). The row labeled “Average GF Length (μm)” is obtained from an arithmetic average for the TABLE 3 data.

TABLE 3
Glass fiber distribution data for Samples 8, 17, and 21.

| | Sample # (50 wt. % GF-reinforced N66) | | | | | |
|---|---|---|---|---|---|---|
| | 8 | | 17 | | 21 | |
| | RV | | | | | |
| | 26 | | 38 | | 48 | |
| | Average GF length (μm) | | | | | |
| | 243 | | 219 | | 211 | |
| GF length (μm) | Counts | % | Counts | % | Counts | % |
| <100 | 186 | 17.55 | 281 | 18.99 | 447 | 23.03 |
| 100-200 | 280 | 26.42 | 429 | 28.99 | 535 | 27.56 |
| 200-300 | 266 | 25.09 | 397 | 26.82 | 518 | 26.69 |
| 300-400 | 179 | 16.89 | 250 | 16.89 | 276 | 14.22 |
| 400-500 | 93 | 8.77 | 88 | 5.95 | 114 | 5.87 |
| 500-600 | 27 | 2.55 | 29 | 1.96 | 33 | 1.70 |
| 600-700 | 17 | 1.60 | 4 | 0.27 | 14 | 0.72 |
| 700-800 | 10 | 0.94 | 2 | 0.14 | 1 | 0.05 |
| 800-900 | 0 | 0.00 | 0 | 0.00 | 3 | 0.15 |
| >900 | 2 | 0.19 | 0 | 0.00 | 0 | 0.00 |
| Total Counts | 1060 | | 1480 | | 1941 | |

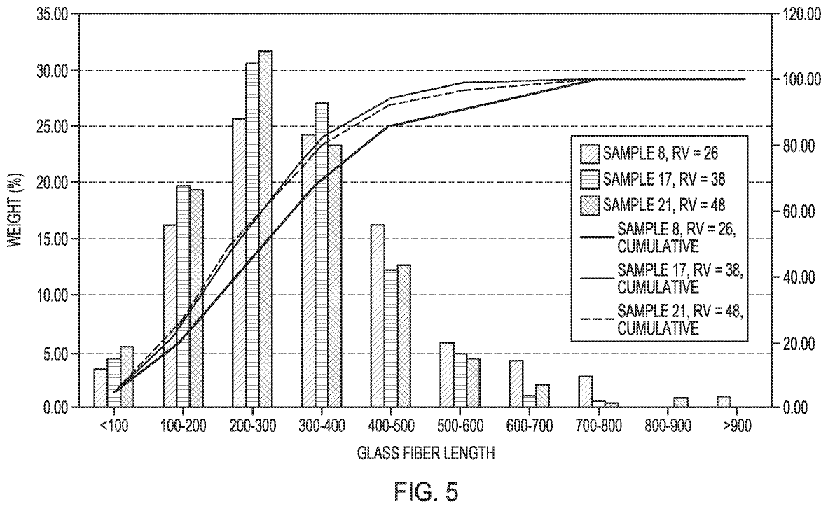

In FIG. 5, the data from Table 3 are plotted using the GF length (μm) on the X-axis and the corresponding % values on the Y-axis in the form of bar chart for Samples 8, 17, and 21. The bar chart data shows that the GF length distribution is mostly concentrated in the 200-400 μm range. The lines are cumulative distributions to show the bulk distribution of the GF length for each analyzed sample. Both from the averaged values and weight average distribution trends, it is observed that there are more long fibers in Sample 8, the 26 RV sample, than Samples 17 (RV=38) or 21 (RV=48).

It is hypothesized that the lower RV Sample has more long glass fibers due to less shear work being required to form the blend as compared to blends including higher RV polyamides.

### Example 6. End Group Analysis

Table 4 illustrates end group analysis data for the polyamides used to form Samples 4-7 (RV=25), Samples 9-12 (RV=30), and Samples 13-15 (RV=35).

TABLE 4
End group analysis. Viscosity index is given as 0.5 wt % in sulfuric acid,
and is calculated via ISO 307. RV is given as 8.4 wt % in 90% formic acid.
AEG is amine end groups measured in moles per million grammes (mpmg). CEG
is carboxyl end groups, and was calculated from AEG, TEG, and AcOH, all having
the units of moles per million grammes (mpmg). Acetic acid (AcOH) was added
as inert end groups. TEG (SE) is total end groups, and was calculated from
RV by empirical formula. DE is difference of ends, calculated as (CEG −
AEG) difference having the units of measured in moles per million grammes (mpmg).

| | Viscosity | | | | | TEG | |
|---|---|---|---|---|---|---|---|
| Polyamide | Index | | AEG | CEG | AcOH | (SE) | DE |
| used in | (Viscosity | | mpmg | mpmg | mpmg | mpmg | mpmg |
| Sample #s: | Number) | RV | (meq/kg) | (meq/kg) | (meq/kg) | (meq/kg) | (meq/kg) |
| 4-7 | 83.9 | 25 | 56 | 72 | 54.5 | 182.5 | 16.0 |
| 9-12 | 100.4 | 30 | 56 | 71.6 | 33.5 | 161.6 | 15.6 |
| 13-15 | 114.3 | 35 | 56 | 72.2 | 18.3 | 146.5 | 16.2 |

### Exemplary Aspects.

The following exemplary aspects are provided, the numbering of which is not to be construed as designating levels of importance:

Aspect 1 provides a glass fiber-filled polyamide composition comprising:

a polyamide having a relative viscosity (RV) of from >22 to <30.2; and

from ≥10 to ≤62 weight percent glass fibers blended with the polyamide, based on the weight of the polyamide including the glass fibers.

Aspect 2 provides the glass fiber-filled polyamide composition of Aspect 1, wherein the tensile strength of the composition, measured in accordance with ASTM D638-14, is inversely related to the RV of the polyamide.

Aspect 3 provides the glass fiber-filled polyamide composition of any one of Aspects 1-2, wherein the polyamide has a RV of from ≥22 to ≤30.0.

Aspect 4 provides the glass fiber-filled polyamide composition of any one of Aspects 1-3, wherein the polyamide has a RV of from ≥22 to ≤29.

Aspect 5 provides the glass fiber-filled polyamide composition of any one of Aspects 1-4, wherein the polyamide has a RV of from ≥23 to ≤27.

Aspect 6 provides the glass fiber-filled polyamide composition of any one of Aspects 1-5, wherein the tensile strength of the composition having an RV of from ≥24 to ≤26 comprising a maximum loading of the glass fibers is greater than the tensile strength of the composition having an RV from ≥29 to ≤31 comprising a maximum loading of the glass fibers, both measured in accordance with ASTM D638-14.

Aspect 7 provides the glass fiber-filled polyamide composition of any one of Aspects 1-6, wherein ≥15 weight percent to ≤60 weight percent of the composition is glass fibers.

Aspect 8 provides the glass fiber-filled polyamide composition of any one of Aspects 1-7, wherein ≥18 weight percent to ≤50 weight percent of the composition is glass fibers.

Aspect 9 provides the glass fiber-filled polyamide composition of any one of Aspects 1-8, wherein ≥20 weight percent to ≤40 weight percent of the composition is glass fibers.

Aspect 10 provides the glass fiber-filled polyamide composition of any one of Aspects 1-9, wherein ≥30 weight percent to ≤50 weight percent of the composition is glass fibers.

Aspect 11 provides the glass fiber-filled polyamide composition of any one of Aspects 1-10, wherein ≥40 weight percent of the composition is the polyamide.

Aspect 12 provides the glass fiber-filled polyamide composition of any one of Aspects 1-11, wherein ≥50 weight percent of the composition is the polyamide.

Aspect 13 provides the glass fiber-filled polyamide composition of any one of Aspects 1-12, wherein the polyamide AEG value (amine end groups) is in the range of ≥30 to ≤90 moles per million grams (mpmg).

Aspect 14 provides the glass fiber-filled polyamide composition of any one of Aspects 1-13, wherein the glass fiber-filled polyamide composition has an elongation-at-break of 4% to 20%.

Aspect 15 provides the glass fiber-filled polyamide composition of any one of Aspects 1-14, wherein the glass fiber-filled polyamide composition has an elongation-at-break of 4% to 6%.

Aspect 16 provides the glass fiber-filled polyamide composition of any one of Aspects 1-15, wherein the glass fiber-filled polyamide composition has an elongation-at-break of 4.3% to 5.2%.

Aspect 17 provides the glass fiber-filled polyamide composition of any one of Aspects 1-16, wherein at least 5 wt % of the glass fibers have a length of equal to or greater than 700 microns.

Aspect 18 provides the glass fiber-filled polyamide composition of any one of Aspects 1-17, wherein at least 15 wt % of the glass fibers have a length of equal to or greater than 600 microns.

Aspect 19 provides the glass fiber-filled polyamide composition of any one of Aspects 1-18, wherein the polyamide comprises polyhexamethlyeneadipamide (PA66), polycaproamide (PA6), polyenanthamide (PA7), polylaurolactamide (PA12), polyundecaneamide (PA11), polyhexamethylenedodecamide (PA612), a copolymer of one or more of the preceding, a copolymer of one or more of the preceding and of 6T, or any combination thereof.

Aspect 20 provides the glass fiber-filled polyamide composition of any one of Aspects 1-19, wherein the polyamide is nylon 66.

Aspect 21 provides a glass fiber-filled polyamide composition comprising:

a polyamide having a relative viscosity (RV) of from ≥20 to ≤36; and

from ≥10 to ≤62 weight percent glass fibers blended with the polyamide, based on the weight of the polyamide including the glass fibers;

wherein the glass fiber-filled polyamide composition has an elongation-at-break of 4% to 20%.

Aspect 22 provides the glass fiber-filled polyamide composition of Aspect 21, wherein the glass fiber-filled polyamide composition has an elongation-at-break of 4% to 6%.

Aspect 23 provides the glass fiber-filled polyamide composition of any one of Aspects 21-22, wherein the glass fiber-filled polyamide composition has an elongation-at-break of 4.3% to 5.2%.

Aspect 24 provides the glass fiber-filled polyamide composition of any one of Aspects 21-23, wherein the polyamide RV is from ≥20 to ≤33.

Aspect 25 provides the glass fiber-filled polyamide composition of any one of Aspects 21-24, wherein the polyamide RV is from ≥21 to ≤32.

Aspect 26 provides the glass fiber-filled polyamide composition of any one of Aspects 21-25, wherein the polyamide RV is from ≥22 to ≤30.2.

Aspect 27 provides the glass fiber-filled polyamide composition of any one of Aspects 21-26, wherein the polyamide RV is from ≥20 to ≤30.0.

Aspect 28 provides the glass fiber-filled polyamide composition of any one of Aspects 21-27, wherein the polyamide RV is from ≥22 to ≤29.

Aspect 29 provides the glass fiber-filled polyamide composition of any one of Aspects 21-28, wherein the polyamide RV is ≥23 to ≤27.

Aspect 30 provides the glass fiber-filled polyamide composition of any one of Aspects 21-29, wherein the tensile strength of the composition, measured in accordance with ASTM D638-14, is inversely related to the RV of the polyamide.

Aspect 31 provides the glass fiber-filled polyamide composition of any one of Aspects 21-30, wherein the tensile strength of the composition having an RV of from ≥24 to ≤26 comprising a maximum loading of the glass fibers is greater than the tensile strength of the composition having an RV from ≥29 to ≤31 comprising a maximum loading of the glass fibers, both measured in accordance with ASTM D638-14.

Aspect 32 provides the glass fiber-filled polyamide composition of any one of Aspects 21-31, wherein ≥15 weight percent to ≤60 weight percent of the composition is glass fibers.

Aspect 33 provides the glass fiber-filled polyamide composition of any one of Aspects 21-32, wherein ≥18 weight percent to ≤50 weight percent of the composition is glass fibers.

Aspect 34 provides the glass fiber-filled polyamide composition of any one of Aspects 21-33, wherein ≥20 weight percent to ≤40 weight percent of the composition is glass fibers.

Aspect 35 provides the glass fiber-filled polyamide composition of any one of Aspects 21-34, wherein ≥30 weight percent to ≤50 weight percent of the composition is glass fibers.

Aspect 36 provides the glass fiber-filled polyamide composition of any one of Aspects 21-35, wherein ≥40 weight percent of the composition is the polyamide.

Aspect 37 provides the glass fiber-filled polyamide composition of any one of Aspects 21-36, wherein ≥50 weight percent of the composition is the polyamide.

Aspect 38 provides the glass fiber-filled polyamide composition of any one of Aspects 21-37, wherein the polyamide AEG value (amine end groups) is in the range of ≥30 to ≤90 moles per million grams (mpmg).

Aspect 39 provides the glass fiber-filled polyamide composition of any one of Aspects 21-38, wherein at least 5 wt % of the glass fibers have a length of equal to or greater than 700 microns.

Aspect 40 provides the glass fiber-filled polyamide composition of any one of Aspects 21-39, wherein at least 15 wt % of the glass fibers have a length of equal to or greater than 600 microns.

Aspect 41 provides the glass fiber-filled polyamide composition of any one of Aspects 21-40, wherein the polyamide comprises polyhexamethlyeneadipamide (PA66), polycaproamide (PA6), polyenanthamide (PA7), polylaurolactamide (PA12), polyundecaneamide (PA11), polyhexamethylenedodecamide (PA612), a copolymer of one or more of the preceding, a copolymer of one or more of the preceding and of 6T, or any combination thereof.

Aspect 42 provides the glass fiber-filled polyamide composition of any one of Aspects 21-41, wherein the polyamide is nylon 66.

Aspect 43 provides a glass fiber-filled polyamide composition comprising:

a polyamide having a relative viscosity (RV) of from ≥20 to ≤36; and

from ≥10 to ≤62 weight percent glass fibers blended with the polyamide, based on the weight of the polyamide including the glass fibers;

wherein at least 5 wt % of the glass fibers have a length of equal to or greater than 700 microns.

Aspect 44 provides the glass fiber-filled polyamide composition of Aspect 43, wherein at least 15 wt % of the glass fibers have a length of equal to or greater than 600 microns.

Aspect 45 provides the glass fiber-filled polyamide composition of any one of Aspects 43-44, wherein the tensile strength of the composition, measured in accordance with ASTM D638-14, is inversely related to the RV of the polyamide.

Aspect 46 provides the glass fiber-filled polyamide composition of any one of Aspects 43-45, wherein the polyamide RV is from ≥20 to ≤33.

Aspect 47 provides the glass fiber-filled polyamide composition of any one of Aspects 43-46, wherein the polyamide RV is from ≥21 to ≤32.

Aspect 48 provides the glass fiber-filled polyamide composition of any one of Aspects 43-47, wherein the polyamide RV is from ≥22 to ≤30.2.

Aspect 49 provides the glass fiber-filled polyamide composition of any one of Aspects 43-48, wherein the polyamide RV is from ≥22 to ≤30.0.

Aspect 50 provides the glass fiber-filled polyamide composition of any one of Aspects 43-49, wherein the polyamide RV is from ≥22 to ≤29.

Aspect 51 provides the glass fiber-filled polyamide composition of any one of Aspects 43-50, wherein the polyamide RV is ≥23 to ≤27.

Aspect 52 provides the glass fiber-filled polyamide composition of any one of Aspects 43-51, wherein the tensile strength of the composition having an RV of from ≥24 to ≤26 comprising a maximum loading of the glass fibers is greater than the tensile strength of the composition having an RV from ≥29 to ≤31 comprising a maximum loading of the glass fibers, both measured in accordance with ASTM D638-14.

Aspect 53 provides the glass fiber-filled polyamide composition of any one of Aspects 43-52, wherein ≥15 weight percent to ≤60 weight percent of the composition is glass fibers.

Aspect 54 provides the glass fiber-filled polyamide composition of any one of Aspects 43-53, wherein ≥18 weight percent to ≤50 weight percent of the composition is glass fibers.

Aspect 55 provides the glass fiber-filled polyamide composition of any one of Aspects 43-54, wherein ≥20 weight percent to ≤40 weight percent of the composition is glass fibers.

Aspect 56 provides the glass fiber-filled polyamide composition of any one of Aspects 43-55, wherein ≥30 weight percent to ≤50 weight percent of the composition is glass fibers.

Aspect 57 provides the glass fiber-filled polyamide composition of any one of Aspects 43-56, wherein ≥40 weight percent of the composition is the polyamide.

Aspect 58 provides the glass fiber-filled polyamide composition of any one of Aspects 43-57, wherein ≥50 weight percent of the composition is the polyamide.

Aspect 59 provides the glass fiber-filled polyamide composition of any one of Aspects 43-58, wherein the polyamide AEG value (amine end groups) is in the range of ≥30 to ≤90 moles per million grams (mpmg).

Aspect 60 provides the glass fiber-filled polyamide composition of any one of Aspects 43-59, wherein the glass fiber-filled polyamide composition has an elongation-at-break of 4% to 20%.

Aspect 61 provides the glass fiber-filled polyamide composition of any one of Aspects 43-60, wherein the glass fiber-filled polyamide composition has an elongation-at-break of 4% to 6%.

Aspect 62 provides the glass fiber-filled polyamide composition of any one of Aspects 43-61, wherein the glass fiber-filled polyamide composition has an elongation-at-break of 4.3% to 5.2%.

Aspect 63 provides the glass fiber-filled polyamide composition of any one of Aspects 43-62, wherein the polyamide comprises polyhexamethlyeneadipamide (PA66), polycaproamide (PA6), polyenanthamide (PA7), polylaurolactamide (PA12), polyundecaneamide (PA11), polyhexamethylenedodecamide (PA612), a copolymer of one or more of the preceding, a copolymer of one or more of the preceding and of 6T, or any combination thereof.

Aspect 64 provides the glass fiber-filled polyamide composition of any one of Aspects 43-63, wherein the polyamide is nylon 66.

Aspect 65 provides a method of making the glass fiber-filled polyamide composition of any one of Aspects 1-64, the method comprising:

blending the polyamide and the glass fibers to form the glass fiber-filled polyamide composition.

1. A glass fiber-filled polyamide composition comprising:
a polyamide having a relative viscosity (RV) of from >22 to <30.2; and
from ≥10 to ≤62 weight percent glass fibers blended with the polyamide, based on the weight of the polyamide including the glass fibers.

2. The glass fiber-filled polyamide composition of claim 1, wherein ≥40 weight percent of the composition is the polyamide.

3. The glass fiber-filled polyamide composition of claim 1, wherein the polyamide AEG value (amine end groups) is in the range of ≥30 to ≤90 moles per million grams (mpmg).

4. The glass fiber-filled polyamide composition of claim 1, wherein the glass fiber-filled polyamide composition has an elongation-at-break of 4% to 20%.

5. The glass fiber-filled polyamide composition of claim 1, wherein at least 5 wt % of the glass fibers have a length of equal to or greater than 700 microns.

6. The glass fiber-filled polyamide composition of claim 1, wherein the polyamide is nylon 66.

7. A glass fiber-filled polyamide composition comprising:
a polyamide having a relative viscosity (RV) of from ≥20 to ≤36; and
from ≥10 to ≤62 weight percent glass fibers blended with the polyamide, based on the weight of the polyamide including the glass fibers;
wherein the glass fiber-filled polyamide composition has an elongation-at-break of 4% to 20%.

8. The glass fiber-filled polyamide composition of claim 7, wherein the polyamide RV is from >22 to <30.2.

9. The glass fiber-filled polyamide composition of claim 7, wherein ≥40 weight percent of the composition is the polyamide.

10. The glass fiber-filled polyamide composition of claim 7, wherein the polyamide AEG value (amine end groups) is in the range of ≥30 to ≤90 moles per million grams (mpmg).

11. The glass fiber-filled polyamide composition of claim 7, wherein at least 5 wt % of the glass fibers have a length of equal to or greater than 700 microns.

12. The glass fiber-filled polyamide composition of claim 7, wherein the polyamide is nylon 66.

13. A glass fiber-filled polyamide composition comprising:
a polyamide having a relative viscosity (RV) of from ≥20 to ≤36; and
from ≥10 to ≤62 weight percent glass fibers blended with the polyamide, based on the weight of the polyamide including the glass fibers;
wherein at least 5 wt % of the glass fibers have a length of equal to or greater than 700 microns.

14. The glass fiber-filled polyamide composition of claim 13, wherein at least 15 wt % of the glass fibers have a length of equal to or greater than 600 microns.

15. The glass fiber-filled polyamide composition of claim 13, wherein the polyamide RV is from >22 to <30.2.

16. The glass fiber-filled polyamide composition of claim 13, wherein ≥40 weight percent of the composition is the polyamide.

17. The glass fiber-filled polyamide composition of claim 13, wherein the polyamide AEG value (amine end groups) is in the range of ≥30 to ≤90 moles per million grams (mpmg)

18. The glass fiber-filled polyamide composition of claim 13, wherein the glass fiber-filled polyamide composition has an elongation-at-break of 4% to 20%.

19. The glass fiber-filled polyamide composition of claim 13, wherein the polyamide is nylon 66.

20. A method of making the glass fiber-filled polyamide composition of claim 1, the method comprising:
blending the polyamide and the glass fibers to form the glass fiber-filled polyamide composition.
